(19) United States
(12) Patent Application Publication
(10) Pub. No.: US 2016/0311159 A1
(43) Pub. Date: Oct. 27, 2016

(54) SYSTEM AND METHOD FOR FORMING AN OBJECT USING ADDITIVE MANUFACTURING PROCESS

(71) Applicant: Caterpillar Inc., Peoria, IL (US)

(72) Inventors: Joseph M. Spanier, Metamora, IL (US); John A. Sherman, Peoria, IL (US); Christopher M. Sketch, Peoria, IL (US); Ajay Dnyandeo Yadav, Aurora, IL (US)

(73) Assignee: Caterpillar Inc, Peoria, IL (US)

(21) Appl. No.: 14/695,099

(22) Filed: Apr. 24, 2015

(51) Int. Cl. B29C 67/00

(52) U.S. Cl. CPC B29C 67/0055; B29C 67/0088; B33Y 10/00

(57) ABSTRACT

A method for forming an object using additive manufacturing process includes obtaining a Three Dimensional (3-D) digital model of the object to be formed; segmenting a work area into a plurality of distinct zones based on the 3-D digital model of the object to be formed; assigning a plurality of print heads to the plurality of zones such that at least one print head is configured to print in at least one of the plurality of zones; printing each of the plurality of zones by the assigned plurality of print heads; and assigning at least one print head from the plurality of print heads to print an intermediate zone lying between a pair of adjacently located zones.

### TECHNICAL FIELD

The present disclosure relates to a system and method for forming an object using additive manufacturing process, and more particularly to an additive manufacturing process using multiple build heads.

### BACKGROUND

Large format Three Dimensional (3-D) printing is a long process that can sometimes require several hours to finish a print. If any errors come up during that time, the print can fail and the entire process needs to be re-done in order to complete the object. In addition to set-ups of the large format 3-D printing, printing with multiple materials or extrusion widths can entail more time than printing with a single material or printing with uniform extrusion widths.

For reference, U.S Publication 2014/0246809 (hereinafter the '809 publication) relates to systems and methods that implement additive manufacturing processes with multiple build heads. The '809 publication discloses an additive manufacturing apparatus that includes a plurality of build heads, each of which are adapted to cause the formation of a structure onto a surface; a substrate; and a translation system. The translation system is associated with at least one of the plurality of build heads and the substrate such that the spatial relationship between the plurality of build heads and the substrate can be controlled. Although utilizing multiple build heads may help offset time previously incurred with use of a single build head, the process of utilizing multiple heads can be optimized to obtain the object in a better turn-around time.

Hence, there is a need for systems and methods that overcome the aforesaid shortcomings and provide for a reduced turn-around time when printing large scale 3-D objects.

### SUMMARY

In one aspect of the present disclosure, a method for forming an object using additive manufacturing process includes obtaining a Three Dimensional (3-D) digital model of the object to be formed; segmenting a work area into a plurality of distinct zones based on the 3-D digital model of the object to be formed; assigning a plurality of print heads to the plurality of zones such that at least one print head is configured to print in at least one of the plurality of zones; printing each of the plurality of zones by the assigned plurality of print heads; and assigning at least one print head from the plurality of print heads to print an intermediate zone lying between a pair of adjacently located zones.

In another aspect of the present disclosure, a method for forming an object using additive manufacturing process includes obtaining a Three Dimensional (3-D) digital model of the object to be formed; segmenting a work area into a plurality of distinct zones based on the 3-D digital model of the object to be formed; assigning a plurality of primary print heads to the plurality of zones such that at least one primary print head is configured to print in at least one of the plurality of zones; printing each of the plurality of zones by the assigned plurality of primary print heads; and assigning a secondary print head that is exclusive from the plurality of primary print heads to print an intermediate zone lying between a pair of adjacently located zones.

In yet another aspect of the present disclosure, a system for forming an object using additive manufacturing process includes a plurality of print heads configured to independently operate on a work area; and a controller operatively coupled to each of the plurality of print heads. The controller is configured to receive a Three Dimensional (3-D) digital model of the object to be formed; segment the work area into a plurality of distinct zones based on the 3-D digital model of the object to be formed; assign the plurality of print heads to the plurality of zones such that at least one print head is configured to print in at least one of the plurality of zones; actuate the plurality of print heads to print in the respective plurality of zones; and assign at least one print head from the plurality of print heads to print an intermediate zone lying between a pair of adjacently located zones.

Other features and aspects of this disclosure will be apparent from the following description and the accompanying drawings.

### BRIEF DESCRIPTION OF THE DRAWINGS

FIG. 1 is a diagrammatic view of a system for forming an object using additive manufacturing process, in accordance with an embodiment of the present disclosure;

FIGS. 2-4 are diagrammatic views of the system from FIG. 1 showing a step-by-step operation in forming the object, in accordance with an embodiment of the present disclosure;

FIG. 5 is a diagrammatic view of the system, in accordance with another embodiment of the present disclosure;

FIGS. 6-8 are diagrammatic views of the system from FIG. 5 showing a step-by-step sequence of operations in forming the object, in accordance with another embodiment of the present disclosure;

FIG. 9 is a flowchart of a method for forming an object using additive manufacturing process, in accordance with an embodiment of the present disclosure; and

FIG. 10 is a flowchart of a method for forming an object using additive manufacturing process, in accordance with another embodiment of the present disclosure.

### DETAILED DESCRIPTION

The present disclosure relates to a system and method for forming an object using additive manufacturing process. Wherever possible the same reference numbers will be used throughout the drawings to refer to same or like parts. Moreover, references to various elements described herein, are made collectively or individually when there may be more than one element of the same type. However, such references are rendered to merely aid the reader's understanding of the present disclosure and hence, to be considered exemplary in nature. Accordingly, it may be noted that any such reference to elements in the singular is also to be construed to relate to the plural and vice versa without limiting the scope of the disclosure to the exact number or type of such elements unless set forth explicitly in the appended claims.

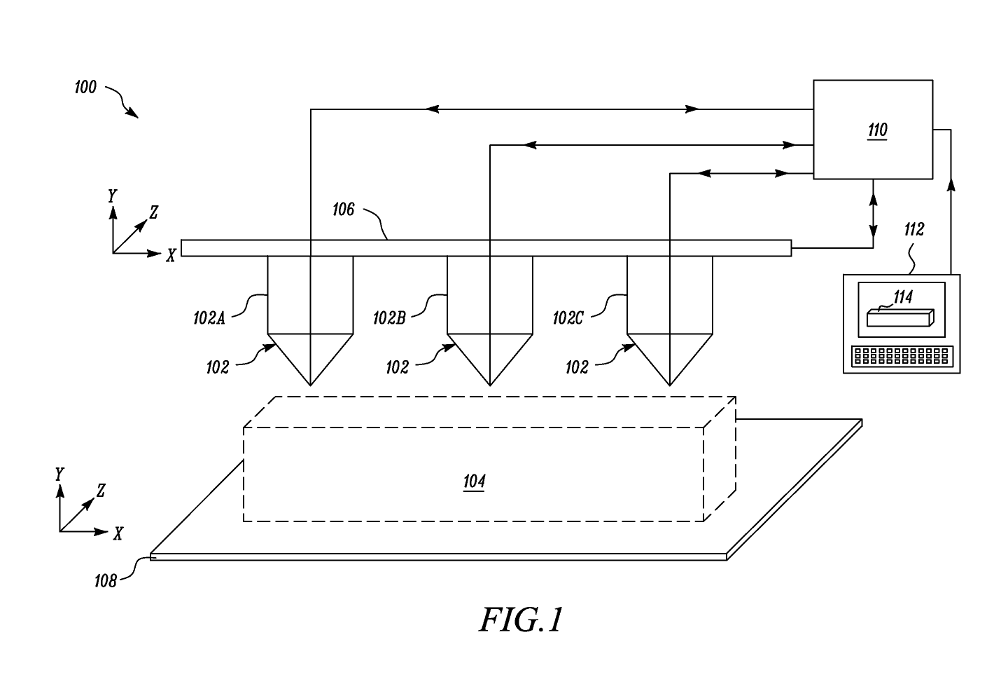

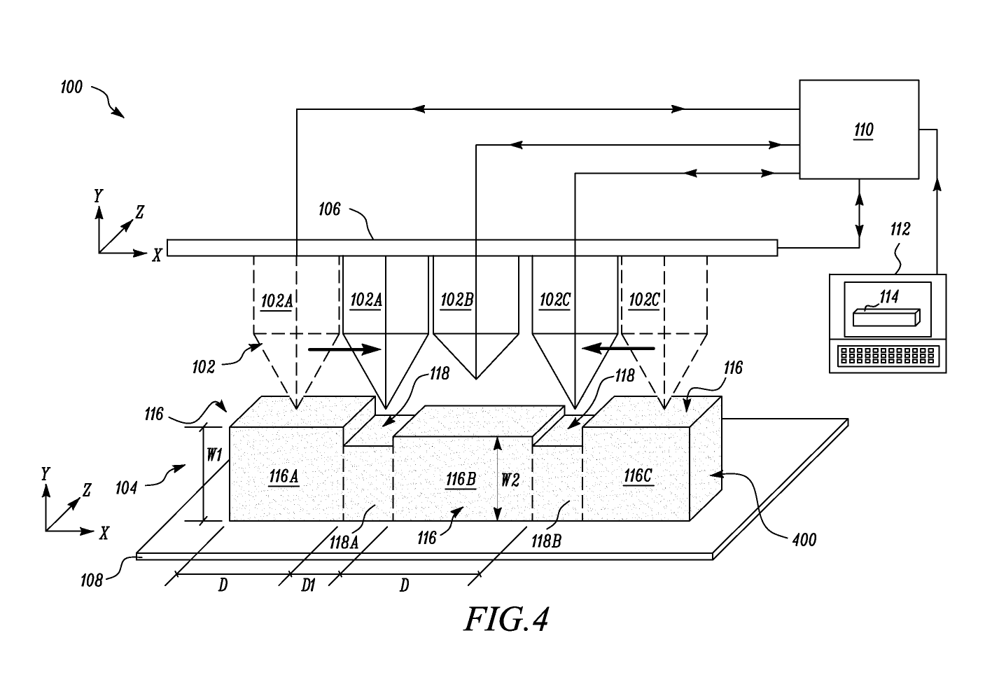

FIG. 1 illustrates a system 100 for forming an object 400 (shown in FIG. 4) using additive manufacturing process, in accordance with an embodiment of the present disclosure. As shown, the system 100 includes multiple print heads 102 that are disposed above a work area 104. For example, three print heads 102 are shown in the illustrated embodiment of FIG. 1 and individually designated with reference numerals ‘102A’, ‘102B’, and ‘102C’. However, it will be appreciated by those skilled in the art that any number of print heads 102 may be utilized based on specific requirements of an application. Each of the print heads 102A, 102B, and 102C can individually or independently operate in relation to one another. As shown, each of the three print heads 102A, 102B, and 102C is coupled to a translation system 106 that allows the three print heads 102A, 102B, and 102C to move independently of one another in X, Y and Z axes (See FIG. 1). Any type of translation system commonly known in the art may be suitably employed to implement an independently moveable relation of the three print heads 102A, 102B, and 102C without deviating from the scope of the present disclosure.

The work area 104, disclosed herein, may be regarded as a volume or space that is overlying a substrate 108. The substrate 108 may be of a stationary or movable type (as shown in FIG. 1) depending on specific requirements of an application. The object 400 to be formed is generally formed on the substrate 108 and within the work area 104 that is defined on the substrate 108 (refer to FIG. 4).

As shown, the system 100 further includes a controller 110 that is operably coupled to each print head 102A, 102B, and 102C. Moreover, in the illustrated embodiment of FIG. 1, the controller 110 is communicably coupled to a computer 112 to receive a Three Dimensional (3-D) digital model 114 of the object 400 to be formed from the computer 112. This computer 112 may be embodied in the form of a general purpose computer having machine readable instructions for generating the 3-D digital model 114 of the object 400 to be formed and/or performing any other functions that are consistent with aspects of the present disclosure. The controller 110 can therefore receive command signals from the computer 112 that are representative of the 3-D digital model 114 of the object 400 and accordingly actuate each of the print heads 102A, 102B, and 102C to move in unison, or individually over the work area 104 when forming the object 400.

Although the controller 110 disclosed herein is being coupled to a computer 112, it will be appreciated that in alternative embodiments, the controller 110 itself can be configured with machine readable instructions to generate the 3-D digital model 114 of the object 400 to be formed. The controller 110 may embody a single microprocessor or multiple microprocessors that include components for individually controlling operations of the multiple print heads 102A, 102B, and 102C based on inputs from an operator and based on sensed or other known operational parameters. Numerous commercially available microprocessors can be configured to perform the functions of the controller 110. It should be appreciated that the controller 110 could readily be embodied in a general machine microprocessor capable of controlling numerous machine functions. The controller 110 may include a memory, a secondary storage device, a processor, and any other components for running an application. Various other circuits may be associated with the controller 110 such as power supply circuitry, signal conditioning circuitry, solenoid driver circuitry, and other types of circuitry. Various routines, algorithms, and/or programs can be programmed within the controller 110 for execution thereof to generate the 3-D digital model 114 of the object 400 to be formed. Therefore, one of ordinary skill in the art will also appreciate that the controller 110 and the computer 112 could be integral to one another, or distinct from one another as shown in the illustrated embodiment of FIG. 1 without deviating from the spirit of the present disclosure.

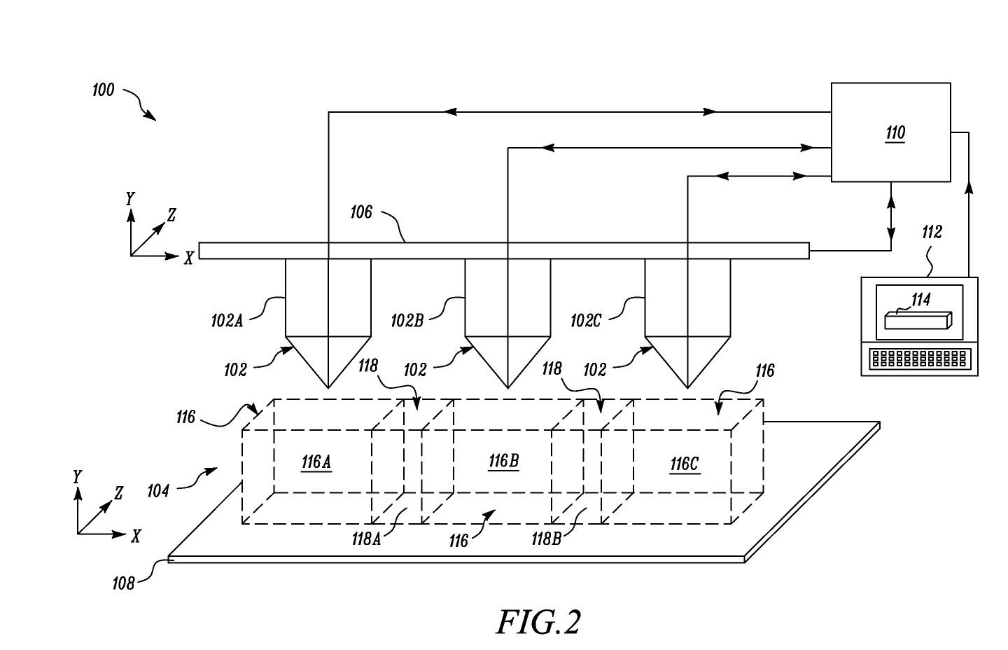

A functioning of the system 100 from FIG. 1 will be explained with reference to FIGS. 2-4 where diagrammatic views of the system 100 showing a step-by-step sequence of operations in forming the object 400 are rendered.

As shown in FIG. 2, the controller 110 is configured to segment the work area 104 into a plurality of distinct zones 116 based on the 3-D digital model 114 of the object 400. For example, in the illustrated embodiment of FIG. 2, the work area 104 has been segmented by the controller 110 into three distinct zones 116, individually designated with reference numerals ‘116A’, ‘116B’, and ‘116C’. However, in other embodiments, the work area 104 can be beneficially segmented into fewer or more number of zones 116 depending on specific requirements of an application. Moreover, when segmenting the work area 104 into zones 116, a distance D of each zone may be similar or dissimilar based on specific requirements of an application.

It is hereby envisioned that as the controller 110 of the present disclosure can communicate with the print heads 102 and the translation system 106 associated with the print heads 102, the controller 110 can optimally segment the work area 104 into multiple zones 116. For example, the controller 110 can beneficially take into account additional factors such as, but not limited to, the number of print heads 102 present in the system 100, a size of the work area 14, a range of movement associated with each print head 102A, 102B, and 102C as individually defined by the translation system 106 for each print head 102A, 102B, and 102C, and the like; and optimally segment the work area 104 into multiple zones 116A, 116B, and 116C based on the 3-D digital model 114 of the object 400. Alternatively, the computer 112 can receive instructions from an operator via an interface (not shown) and these instructions can be communicated to the controller 110 for segmenting the work area 104 into distinct zones 116A, 116B, and 116C.

Further, adjacently located zones 116 i.e., 116A, 116B and 116B, 116C are spaced apart from one another by a small distance D1 that may be regarded as being representative of an intermediate zone 118. Two intermediate zones 118 are individually designated by reference numerals ‘118A’ and ‘118B’. Therefore, as shown in illustrated embodiment of FIG. 2, the zones 116 i.e., 116A, 116B and 116B, 116C are interstitially separated by intermediate zones 118A and 118B respectively, each having a distance D1. The distance D1 is significantly smaller than the distance D and hence, a size of the intermediate zones 118 can be considered to be incomparable with that of the zones 116. However, in other embodiments, the relative sizes of the zones 116 and the intermediate zones 118 may be varied to suit various specific requirements of an application.

With continued reference to FIG. 2, the controller 110 further assigns the print heads 102 to the zones 116 such that at least one print head 102 is configured to print in at least one of the zones 116. In the illustrated embodiment of FIG. 2, the controller 110 can beneficially assign print head 102A to zone 116A, print head 102B to zone 116B, and print head 102C to zone 116C. However, when the number of print heads 102 present in the system 100 is more than the number of zones 116 formed from segmentation of the work area 104, it may be possible for the controller 110 to beneficially assign more than one print head 102 to a zone 116. For example, if six print heads 102 are present and three zones 116 are formed from segmentation of the work area 104, then the controller 110 can assign two print heads 102 to each zone 116 thereby effectively utilizing all the six print heads 102 in additively forming the object 400.

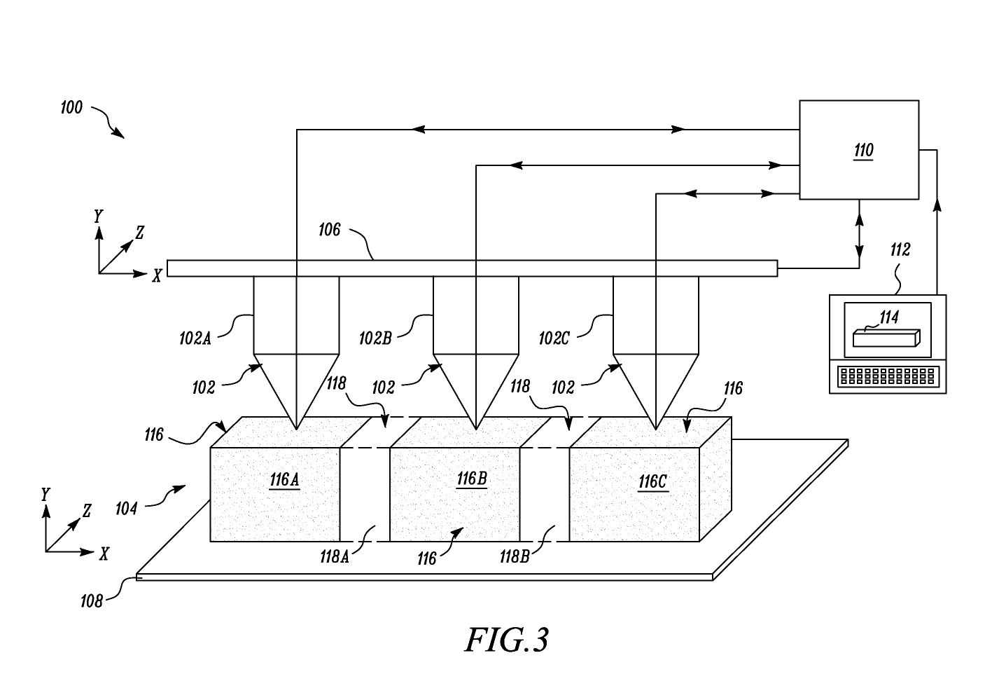

Referring to FIG. 3, the controller 110 further actuates each of the print heads 102A, 102B, and 102C to print within the assigned zones 116A, 116B, and 116C respectively. As shown, the print heads 102 are configured to move within the respective zones 116 and print parts of the object 400 that correspond to the respective zones 116. At this point, parts of the object 400 that correspond to the intermediate zones 118 have not been formed yet.

Referring to FIG. 4, upon completion of the object 400 in part by the three print heads 102A, 102B, and 102C, the controller 110 is configured to further assign at least one print head 102A, 102B, or 102C from the set of print heads 102 to print the intermediate zones 118 i.e., 118A, 118B lying between a pair of adjacently located zones 116 i.e., 116A, 116B and 116B, 116C. For example, as shown in FIG. 4, upon completion of zones 116 i.e., 116A, 116B, and 116C; the controller 110 may assign print head 102A to print within the intermediate zone 118A and print head 102C to print within the intermediate zone 118B. In this manner, the object 400 to be formed may be completed upon printing within the intermediate zones 118A and 118B by the print heads 102A and 102C respectively. However, it may be noted that assigning print heads 102A and 102C is merely exemplary in nature and hence, non-limiting of this disclosure. The controller 110 of the present disclosure can assign any of the available print head/s 102A, 102B, and/or 102C to print within the intermediate zones 118A and 118B upon completion of printing within the zones 116A, 116B, and 116C.

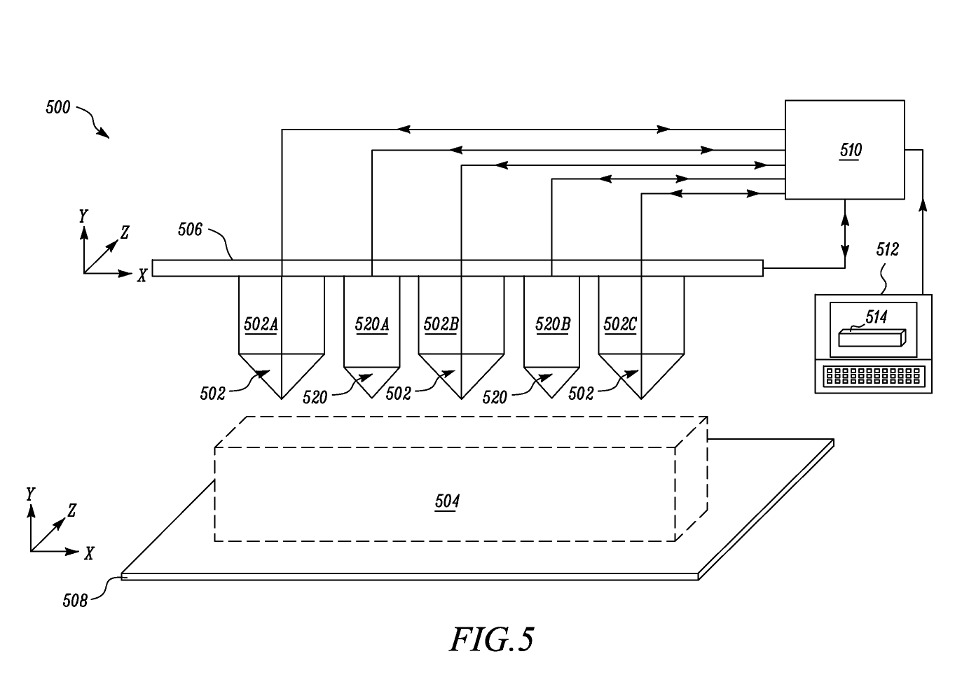

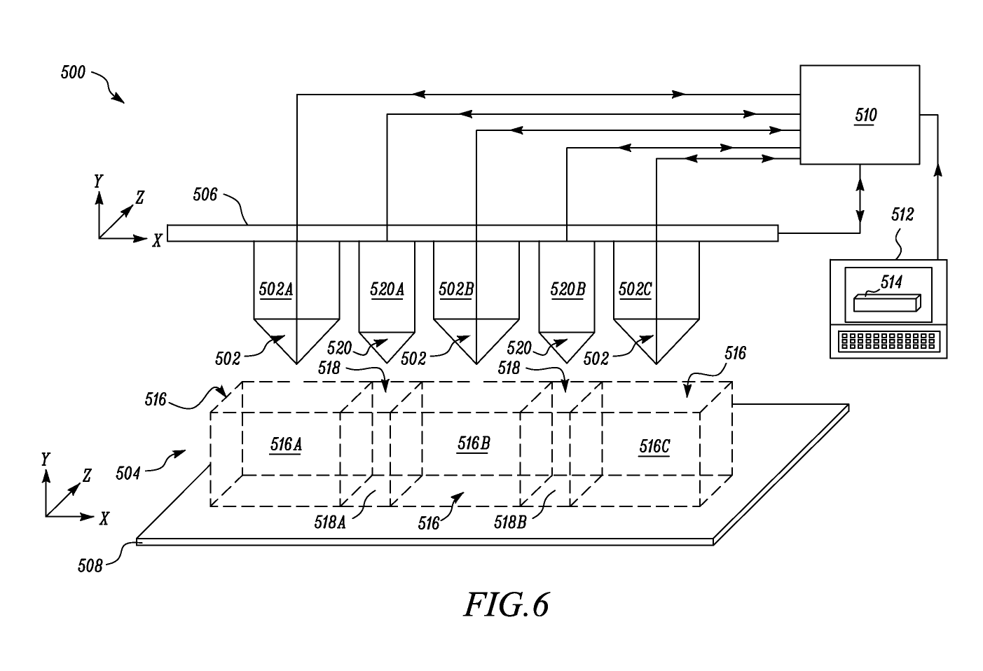

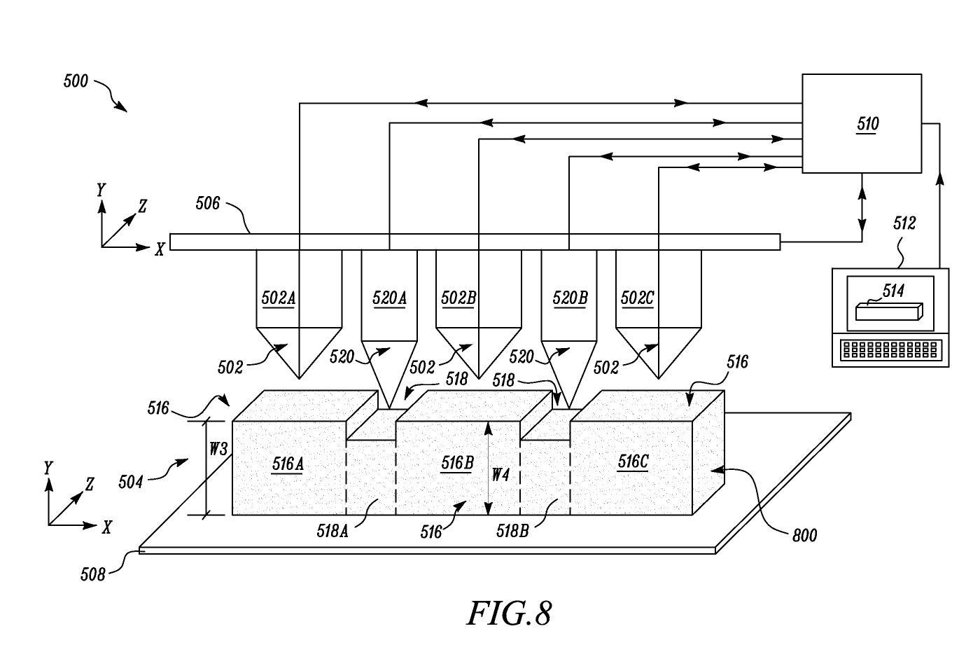

Referring to FIG. 5, a diagrammatic view of a system 500 is illustrated. The system 500 of FIG. 5 is configured for producing an object 800 (shown in FIG. 8) using additive manufacturing in accordance with another embodiment of the present disclosure. Moreover, FIGS. 6-8 illustrate diagrammatic views of the system 500 from FIG. 5 showing a step-by-step sequence of operations in forming the object 800. Since system 500 is generally reminiscent of the system 100 from FIG. 1, components which are similar between the embodiment of FIG. 1 and the embodiment of FIG. 5 will be annotated by similar numerals increased by 400.

Referring to FIG. 5, the system 500 includes multiple primary print heads 502 and multiple secondary print heads 520. Three primary print heads 502 shown in the illustrated embodiment of FIG. 5 and individually designated by numerals ‘502A’, ‘502B’, and ‘502C’. Moreover, two secondary print heads 520 are shown in the illustrated embodiment of FIG. 5 and individually designated by numerals ‘520A’, and ‘520B’. Although three primary print heads 502A, 502B, and 502C; and two secondary print heads 520A, 520B are shown in the illustrated embodiment of FIG. 5, one of ordinary skill in the art will acknowledge that the number of primary print heads 502 and the number of secondary print heads 520 used can vary from one additive manufacturing application to another depending on specific requirements of an associated application.

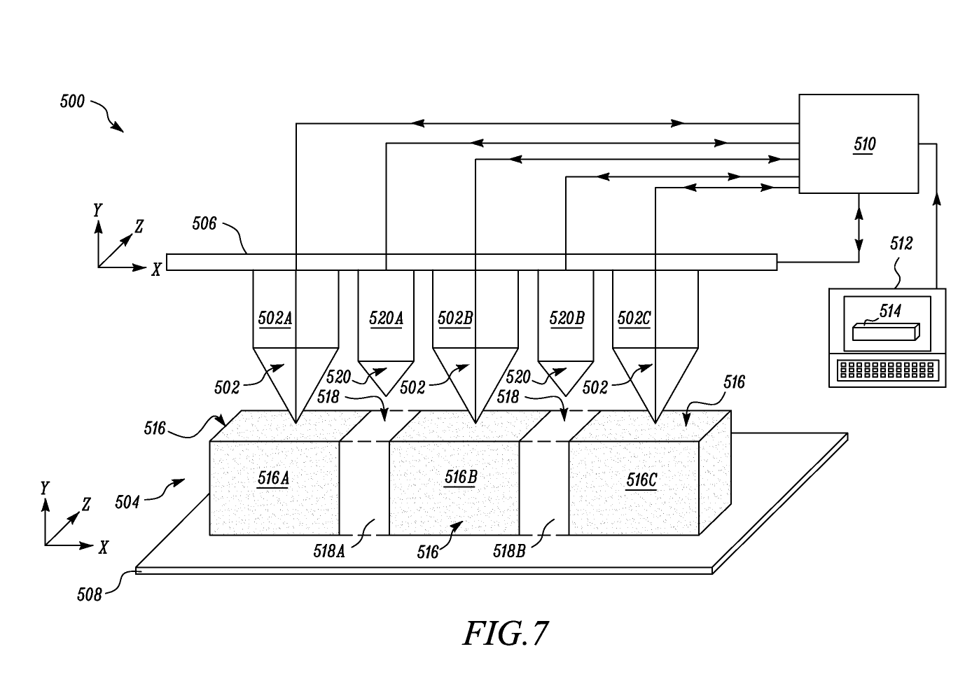

Each of the primary print heads 502A, 502B, and 502C and each of the secondary print heads 520A, 520B are operably coupled to the controller 510 and can receive commands/signals or the 3-D digital model 514 of the object 800 to be formed from the controller 510. As shown in FIG. 6, the controller 510 is configured to segment a work area 504 into a number of zones 516 based on the 3-D digital model 514 of the object 400 to be formed. Further, referring to FIG. 7, the controller 510 further assigns the primary print heads 502 to the zones 516 such that at least one primary print head 502 is configured to print in at least one zone 516. For example, as shown in FIG. 7, the controller 510 can assign primary print head 502A to zone 516A, primary print head 502B to zone 516B, and primary print head 502C to zone 516C. Thereafter, the controller 510 can configure the assigned primary print heads 502 to execute the printing of the corresponding zones 516.

Furthermore, as shown in FIG. 8, the controller 510 now assigns at least one secondary print head 520 to print an intermediate zone 518 lying between a pair of adjacently located zones 516. For example, in the illustrated embodiment of FIG. 8, the controller 510 has assigned the secondary print heads 520A, and 520B to print the intermediate zones 518A, and 518B respectively. The secondary print heads 518 disclosed herein are exclusive from that of the primary print heads 502 and are configured to print within the intermediate zones 518 alone.

Additionally, in various embodiments of the present disclosure, each of the print heads 102 including the primary print heads 502, and each of the secondary print heads 520 is capable of printing or extruding with similar or dissimilar materials in each of the zones 116/516 and intermediate zones 118/518. The materials that can be used by the print heads 102, primary print heads 502, and secondary print heads 520 may include polymers, metals, ceramics and composites, but are not limited thereto. A type or nature of the materials is non-limiting of this disclosure. One of ordinary skill in the art can beneficially contemplate using any type or nature of material depending on specific requirements of the application and without deviating from the spirit of the present disclosure.

Moreover, the print heads 102 and the primary print heads 502 can beneficially print or extrude similar or dissimilar extrusion widths within the respective zones 116, 516 respectively. For example, referring to FIG. 4, extrusion widths W1 and W2 associated with zones 102A and 102B are dissimilar i.e., W1≠W2. In another example as shown in FIG. 8, extrusion width W3 and W4 associated with zones 502A and 502B are similar to one another i.e., W3=W4.

Various embodiments disclosed herein are to be taken in the illustrative and explanatory sense, and should in no way be construed as limiting of the present disclosure. All joinder references e.g., attached, affixed, coupled, engaged, connected, and the like are only used to aid the reader's understanding of the present disclosure, and may not create limitations, particularly as to the position, orientation, or use of the systems, processes, and/or methods disclosed herein. Therefore, joinder references, if any, are to be construed broadly. Moreover, such joinder references do not necessarily infer that two elements are directly connected to each other. Moreover, expressions such as “including”, “comprising”, “incorporating”, “consisting of”, “containing”, “having”, and the like, used to describe and claim the present disclosure, are intended to be construed in a non-exclusive manner, namely allowing for components or elements not explicitly described also to be present.

Additionally, all numerical terms, such as, but not limited to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims

### INDUSTRIAL APPLICABILITY

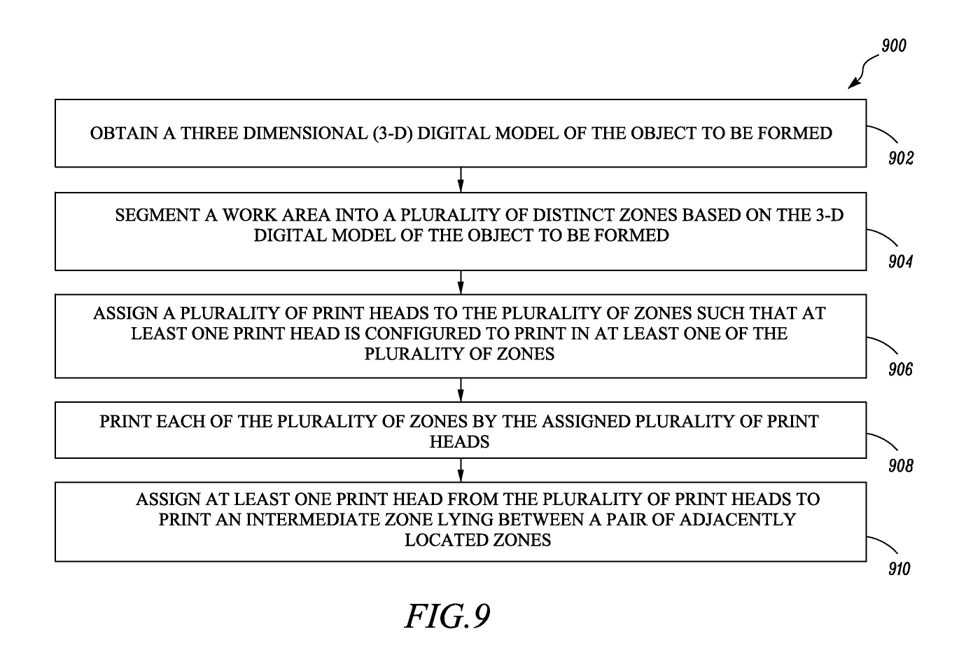

FIG. 9 illustrates a method 900 for forming an object 400 using additive manufacturing process, in accordance with an embodiment of the present disclosure. For purposes of the present disclosure, embodiments disclosed in conjunction with FIGS. 1 to 4 may be considered as being pursuant to the method 900 of FIG. 9. Therefore, for sake of brevity, recapitulation of aspects disclosed in conjunction with FIGS. 1 to 4 has been omitted when rendering steps 902-910 that are associated with the method 900. A reader of this document is therefore advised to refer to FIGS. 1 to 4 for detailed understanding of aspects disclosed in the method 900 of FIG. 9.

Referring to FIG. 9, at step 902, the method 900 includes obtaining a Three Dimensional (3-D) digital model 114 of the object 400 to be formed (refer to FIG. 1). At step 904, the method 900 further includes segmenting the work area 104 into multiple distinct zones 116 i.e., 116A, 116B, and 116C based on the 3-D digital model 114 of the object 400 to be formed (refer to FIG. 2). At step 906, the method 900 further includes assigning the print heads 102 to the zones 116 such that at least one print head 102 is configured to print in at least one of the zones 116 (refer to FIG. 2). At step 908, the method 900 further includes printing each zone 116A, 116B, 116C by the assigned print head 102A, 102B, 102C respectively (refer to FIG. 3). At step 910, the method 900 further includes assigning at least one print head i.e., 102A, 102B, or 102C from the set of print heads 102 to print the intermediate zones 108A, 108B lying between a pair of adjacently located zones 116A, 116B and 116B, 116C respectively (refer to FIG. 4).

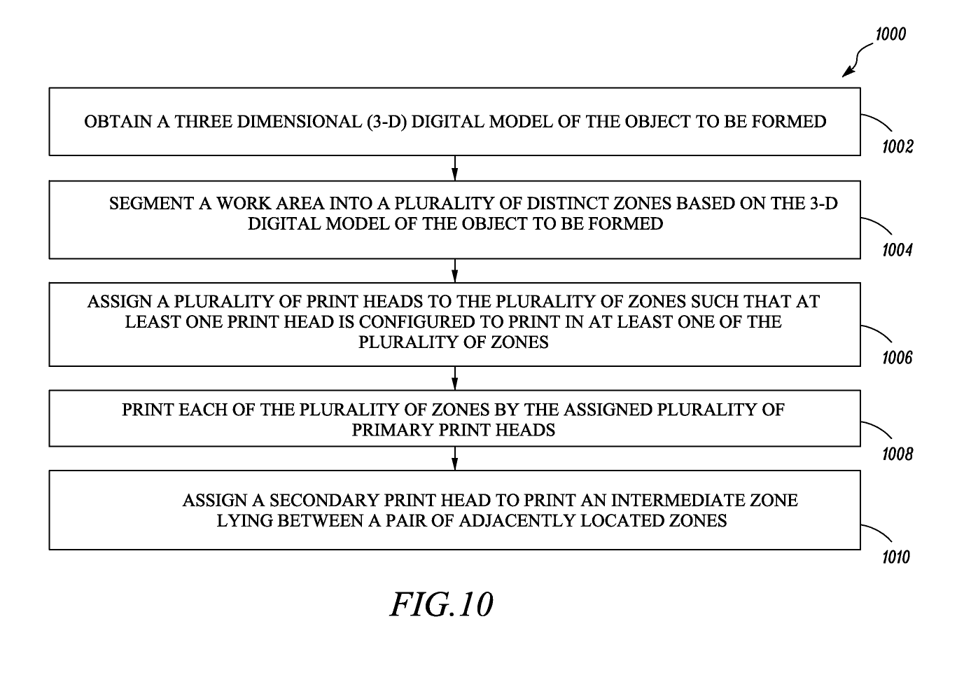

FIG. 10 illustrates a method for forming an object 800 using additive manufacturing process, in accordance with another embodiment of the present disclosure. It may be noted that embodiments disclosed in conjunction with FIGS. 5 to 8 may be considered as being pursuant to the method 1000 of FIG. 10. Therefore, for sake of brevity, recapitulation of aspects disclosed in conjunction with FIGS. 5 to 8 has been omitted when rendering steps 1002-1010 that are associated with the method 1000. A reader of this document is therefore advised to refer to FIGS. 5 to 8 for detailed understanding of aspects disclosed in method 1000 of FIG. 10.

Referring to FIG. 10, at step 1002, the method 1000 includes obtaining a 3-D digital model 514 of the object 800 to be formed (refer to FIGS. 5 and 8). At step 1004, the method 1000 further includes segmenting the work area 504 into multiple distinct zones 516 i.e., 516A, 516B, and 516C based on the 3-D digital model 514 of the object 800 to be formed (refer to FIGS. 6 and 8). At step 1006, the method 1000 further includes assigning primary print heads 502 to the zones 516 such that at least one primary print head i.e., 502A, 502B, and 502C is configured to print in at least one zone i.e., 516A, 516B, and 516C respectively (refer to FIG. 6). At step 1008, the method 1000 further includes printing each zone 516A, 516B, and 516C by the assigned primary print head 502A, 502B, and 502C respectively (refer to FIG. 7). At step 1010, the method 1000 further includes assigning at least one secondary print head 520 that is exclusive from the set of primary print heads 502 to print the intermediate zones 118 that lie between a pair of adjacently located zones 116 (refer to FIG. 8).

Embodiments of the present disclosure have applicability for use and implementation in large format Three Dimensional (3-D) printing. In many cases, large format Three Dimensional (3-D) printing can be a long process that sometimes requires several hours to finish a print. If any errors come up during that time, the print can fail and the entire process needs to be re-done in order to complete printing of the object.

With use of the present disclosure, the work area 104/504 is segmented into numerous zones 116/516 that are distinctly located from one another by the presence of intermediate zones 118/518 therebetween. After segmentation of the work area 104/504 into zones 116/516 and intermediate zones 118/518, printing is initiated in the zones 116/516 while the intermediate zones 118/518 remain empty i.e., the intermediate zones 118/518 are not extruded with any material. If any errors come up when printing a particular zone 116A, 116B, 116C/516A, 516B, 516C, then any material that has been extruded in the particular zone 116A, 116B, 116C/516A, 516B, 516C may be discarded and fresh material may be extruded within the same zone 116A, 116B, 116C/516A, 516B, 516C. This way, it may be possible that errors occurring in a print can be localized to any of the given zones 116A, 116B, 116C/516A, 516B, 516C, and only the zones 116A, 116B, 116C/516A, 516B, 516C having printing errors therein may be discarded and re-printed. Therefore, with use of the present disclosure, costs and time that were previously incurred with re-printing of large format Three Dimensional (3-D) objects can be offset. Moreover, with implementation of embodiments disclosed herein, efforts entailed by an operator in re-printing may be reduced when compared to re-printing a large format 3-D object.

While aspects of the present disclosure have been particularly shown and described with reference to the embodiments above, it will be understood that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A method for forming an object using additive manufacturing process, the method comprising:
obtaining a Three Dimensional (3-D) digital model of the object to be formed;
segmenting a work area into a plurality of distinct zones based on the 3-D digital model of the object to be formed;
assigning a plurality of print heads to the plurality of zones such that at least one print head is configured to print in at least one of the plurality of zones;
printing each of the plurality of zones by the assigned plurality of print heads; and
assigning at least one print head from the plurality of print heads to print an intermediate zone lying between a pair of adjacently located zones.

2. The method of claim 1, wherein each print head from the plurality of print heads is operable independently of one another.

3. The method of claim 1, wherein printing each of the plurality of zones by the assigned plurality of print heads comprises extruding one of similar and dissimilar extrusion widths in each of the plurality of zones.

4. The method of claim 1, wherein printing each of the plurality of zones by the assigned plurality of print heads comprises printing with similar or dissimilar materials in each of the plurality of zones.

5. The method of claim 1, wherein printing each of the plurality of zones by the assigned plurality of print heads comprises extruding one or more of polymers, metals, ceramics and composites in each of the plurality of zones.

6. The method of claim 1, wherein each print head from the plurality of print heads is configured to receive feedstock in the form of at least one of powder and wire.

7. The method of claim 6, wherein each print head from the plurality of print heads is configured to heat the feedstock using one of laser and electron beam.

8. A method for forming an object using additive manufacturing process, the method comprising:
obtaining a Three Dimensional (3-D) digital model of the object to be formed;
segmenting a work area into a plurality of distinct zones based on the 3-D digital model of the object to be formed;
assigning a plurality of primary print heads to the plurality of zones such that at least one primary print head is configured to print in at least one of the plurality of zones;
printing each of the plurality of zones by the assigned plurality of primary print heads; and
assigning at least one secondary print head to print an intermediate zone lying between a pair of adjacently located zones.

9. The method of claim 8, wherein the secondary print head is exclusive from the plurality of primary print heads.

10. The method of claim 8, wherein the secondary print head is capable of extruding one or more of polymers, metals, ceramics and composites in the intermediate zone.

11. The method of claim 8, wherein each print head from the plurality of primary print heads is operable independently of one another.

12. The method of claim 8, wherein printing each of the plurality of zones by the assigned plurality of primary print heads comprises extruding one of similar and dissimilar extrusion widths in each of the plurality of zones.

13. The method of claim 8, wherein printing each of the plurality of zones by the assigned plurality of primary print heads comprises printing with similar or dissimilar materials in each of the plurality of zones.

14. The method of claim 8, wherein printing each of the plurality of zones by the assigned plurality of primary print heads comprises extruding one or more of polymers, metals, ceramics and composites in each of the plurality of zones.

15. A system for forming an object using additive manufacturing process, the system comprising:
a plurality of print heads configured to independently operate on a work area;
a controller operatively coupled to each of the plurality of print heads, the controller configured to:
receive a Three Dimensional (3-D) digital model of the object to be formed;
segment the work area into a plurality of distinct zones based on the 3-D digital model of the object to be formed;
assign the plurality of print heads to the plurality of zones such that at least one print head is configured to print in at least one of the plurality of zones;
actuate the plurality of print heads to print in the respective plurality of zones; and
assign at least one print head from the plurality of print heads to print an intermediate zone lying between a pair of adjacently located zones.

16. The system of claim 15, wherein each print head from the plurality of print heads is capable of extruding one of similar and dissimilar materials in the corresponding zone.

17. The system of claim 15, wherein each print head from the plurality of print heads is configured to extrude one of similar and dissimilar extrusion widths in the corresponding zone.

18. The system of claim 15, wherein each print head from the plurality of print heads is configured to extrude one or more of polymers, metals, ceramics and composites in the corresponding zone.

19. The system of claim 15, wherein each print head from the plurality of print heads is configured to receive feedstock in the form of one of powder and wire.

20. The system of claim 19, wherein each print head from the plurality of print heads is configured to heat the feedstock using one of laser and electron beam.
